(19) United States
(12) Patent Application Publication
(10) Pub. No.: US 2021/0223208 A1
(43) Pub. Date: Jul. 22, 2021

(54) METHOD AND SYSTEM FOR THE ANALYSIS OF ANALYTES THROUGH MECHANICAL RESONANCE TRANSDUCTION

(71) Applicant: CONSEJO SUPERIOR DE INVESTIGACIONES CIENTIFICAS (CSIC), Madrid (ES)

(72) Inventors: Eduardo GIL SANTOS, Madrid (ES); Jose Jaime RUZ MARTINEZ, Madrid (ES); Oscar MALVAR VIDAL, Madrid (ES); Javier TAMAYO DE MIGUEL, Madrid (ES); Montserrat CALLEJA GOMEZ, Madrid (ES)

(21) Appl. No.: 17/058,038

(22) PCT Filed: May 27, 2019
(86) PCT No.: PCT/EP2019/063680

§ 371 Date: Nov. 23, 2020

(30) Foreign Application Priority Data
May 28, 2018 (EP) 18382364.0

(51) Int. Cl. G01N 29/02; G01N 29/036; G01N 29/24; G01N 29/34; G02B 6/293

(52) U.S. Cl. CPC G01N 29/022; G01N 29/036; G01N 29/2418; G01N 29/348; G01N 2291/106; G01N 2291/02466; G01N 2291/0256; G01N 2291/0427; G02B 6/29338

(57) ABSTRACT

The invention relates to a method and a system of mechanical resonance transduction for analyte analysis, suitable for its use in the identification of nanoparticles in the range between 1 MHz and 300 GHz, said method being characterized in that it comprises the following steps: a) disposing at least one analyte, possessing at least one mechanical vibration mode, on at least one mechanical resonator sensor that possesses at least one mechanical vibration mode, selectable in a plurality of working frequencies; b) monitoring the mechanical spectra of the of the analyte and the resonator sensor; c) varying the at least one mechanical vibration mode until at least one mechanical vibration mode reaches a strong coupling situation with the at least one mechanical vibration mode; d) collecting the frequency data at which the strong coupling occurs; e) estimating the resonance frequency and quality factor of the at least one mechanical vibration mode from the strong coupling frequency data obtained in step d).

### FIELD OF THE INVENTION

The present invention relates generally to methods that use small scale mechanical resonators for the detection of analytes, and more particularly to a method and system for analyte detection by using millimetre, micro and nanoscale mechanical resonators with vibration modes at high frequencies, in the order of magnitude of MHz or GHz. The method and system of the present invention allows the measurement of the mechanical resonance frequency of analytes such as bacteria, viruses or nanoentities. The main field of application of the invention is the technology of mechanical transducers based on microresonators.

### BACKGROUND OF THE INVENTION

Since the invention of the Atomic Force Microscopy (AFM), sensors based on nanomechanical resonators have been developed for mass, stress, temperature or force detection. Typically, these devices and methods of detection are based on the measurement of changes in the mechanical resonance of the resonator attributed to the presence of the substance or particle that is to be detected.

Particularly, mass detectors have an extended use due to the simple theoretical models required to estimate the mass of an analyte from the changes in the mechanical resonance of a resonator when such mass is placed on it. In this particular case, the mechanical resonance of an oscillator (resonator) comes defined by the following expression:

$${ω}_{mec}^{2} = \frac{{m}_{eff}}{{k}_{eff}} \qquad ( Eq . 1 )$$

Where ωₘₑₜ² is the squared mechanical resonance of the resonator, is the effective mass and k_{aff} is the stiffness of the resonator. When the analyte is disposed on the resonator, the mechanical response and modes will change, because a change in the effective mass is produced and thus in its resonance frequency as Δω_{mec}:

$${Δω}_{mec} = \frac{1}{2} {m}_{analyte} / {m}_{eff} \qquad ( Eq . 2 )$$

Such difference can be measured with the help of another external detector; that is, the use of any of the conventional optical and/or electrical methods of detection (beam deflection, interferometry, optomechanics, capacitive methods, electrostatic methods, etc.) Any of these methods use in the final step an oscilloscope, frequency locking, spectrum analyzer, high speed acquisition card, etc., for monitoring the mechanical resonance frequencies.

The aforementioned method of identification and quantification of cell building blocks, such as proteins and nucleic acids, by their mass is crucial for the discovery of new disease biomarkers enabling early disease detection and personalized medicine.

Even though rapid advancements in micro- and nanofabrication technologies have allowed researchers to miniaturize the resonators to achieve the ultimate mass detection limit, most of these results were obtained in high-vacuum conditions. Masses recorded rapidly evolved from the picogram (10⁻¹² g; mass of Escherichia coli), achieved with a microcantilever, to the yoctogram (10⁻²⁴ g; the proton mass), and achieved with a suspended carbon nanotube.

Translation of these achievements to liquids, the natural environment for biology, has remained elusive because of the very high energy loss in viscous environments. The energy loss is quantified by the quality factor Q, which is defined as the ratio between the resonance frequency and the width of the resonant peak, but effectively it represents the ratio between the stored mechanical energy and the energy loss during oscillations. The main source of dissipation in mechanical resonators comes from the viscous damping: the Q factor in liquids is at least three orders of magnitude lower than in vacuum.

To summarize, as soon as the analyte to be detected diminishes it size, some drawbacks arise:
1) The smaller the analyte, the smaller the change in the resonance frequency to detect. Thus, smaller mechanical resonators are required, in order to increase the sensitivity for nanoentity detection.
2) On the other hand, diminishing the size of the resonator hampers the detection of the vibration and mechanical resonance. Also, if the size of the resonator is too small, the amplitude of vibration of most resonators is significantly reduced when immersed in fluids, due to dissipation, being it more difficult and complex to detect these vibrations.
3) The most sensitive detection methods for vibration and analyte analysis are based on optomechanical devices. However, even such methods become limited when using resonators with dimensions below the visible wavelength (corresponding to sizes of the nanoscale). In this context, it is understand by non-optically measurable, the mechanical resonances from those resonators whose average dimensions, d, are under the wavelength, A, divided by 4n, being n the refraction index of the medium: d<λ/4n. Also, there would be non-optically measurable frequencies those of the resonators that are made from a material which optical properties are non-compatible (i.e. high absorbance or low reflectance).
   On the other hand, it is understood by non-electrically measurable, the mechanical resonances from those resonators which are made from a material which electrical properties are non-compatible (i.e. isolator) or resonators immersed in certain fluids. As a consequence of the aforementioned criteria, it is understand by “measurable mechanical resonances” those frequency mechanical resonances from resonators that are optically and electrically measurable.
4) On the other hand, the miniaturization of mechanical resonators for analyte detection has shown that the presence of an analyte produces changes in the resonance frequency of the resonator not only due to the added mass, but also due to the stiffness of the analyte. Such parameters have been typically estimated through frequency changes:

$${Δω}_{mec} = \frac{1}{2} {m}_{analyte} / {m}_{eff} + \frac{1}{2} {k}_{analyte} / {k}_{eff} \qquad ( Eq . 3 )$$

In order to overcome the aforementioned difficulties for analyte detection, efforts have been focused on amplifying the signal of the microresonators, diminishing the mechanical dissipation or increasing the displacement sensitivity, for instance, through arrays of microresonators or even through theoretical models that determine the way resonators can be improved in shape, dimensions or materials. As an example, an optomechanical device based on semiconductor disks with a very low mass, acting as a mechanical resonator with radial modes has shown to oscillate in liquids efficiently for analyte detection.

However, given the reduced size of nanoparticles such as bacteria, viruses or proteins, more complex resonators will be necessary in order to perform ultrasensitive mass measurements with the proper detection accuracy in biological environments.

Given the above, there is still need of providing with a method of detection for nanoparticles and analytes, capable of univocally detect and identify an analyte even at the nanoscale size and/or if the system is immersed in a fluid.

Accordingly, there is a need of solutions allowing a further improvement of analyte detection. The present invention proposes a solution to said need by a novel method for analyte detection and analysis, based on the estimation of the resonance frequency of the analyte itself, which none of the prior art methods allows so far. Furthermore, the present invention provides with a solution that overcomes the aforementioned drawbacks, since it is based on the detection of the coupling of the mechanical vibration modes of the analyte with the mechanical vibration modes of the microresonator, thus not being based on measuring changes in the frequency of the resonator.

Even though there are some known approaches on this problem in the state of the art, such as patent applications WO 01/01121 A1, EP 3153844 A1, US 2015/285728 A1, EP 3067723 A1 or the article “Hydration-dehydration of adsorbed protein films studied by AFM and QCM-D” (Lubarsky et al.), none of them allows analyte detection and identification based on coupling the vibration mode of the analyte with the vibration mode of the mechanical resonator sensor.

It is thus an object of the present invention, although without limitation, to provide a method of mechanical resonance transduction for analyte detection or analysis, suitable for the estimation of the mechanical resonances of an analyte and to univocally identify analytes and nanoparticles even in fluids.

### BRIEF DESCRIPTION OF THE INVENTION

The object of the present invention relates, without limitation, to the development of a method of mechanical resonance transduction for analyte vibration detection according to any of the claims, suitable for its use in the identification of bacteria, viruses, proteins or nanoparticles in the range of frequency between 1 MHz and 300 GHz. Advantageously, said method comprises the following steps:
a) disposing at least one analyte that is to be detected on at least one mechanical resonator sensor, wherein said analyte possesses at least one mechanical vibration mode and said mechanical resonator sensor possesses at least one measurable mechanical vibration mode selectable in one or more working frequencies;
b) monitoring the mechanical spectra of the coupled system conformed by the analyte and the mechanical resonator sensor;
c) selecting the working frequency of one mechanical vibration mode of the mechanical resonator sensor to approach the mechanical vibration mode of the analyte, until at least one mechanical vibration mode of the mechanical resonator sensor strongly couples with one mechanical vibration mode of the analyte;
d) determining the frequency at which the strong coupling occurs from the mechanical spectra measured in step b);
e) estimating the resonance frequency and quality factor of the mechanical vibration mode of the analyte from the strong coupling frequency obtained in step d).

In that way, the method of the invention allows analyte detection and identification, based on the strong coupling between the vibration mode of the analyte and the vibration mode of the mechanical resonator sensor.

With the method of the invention, ultrasensitive mass detectors can be achieved but, more importantly, a new characterization technique is shown. New parameters related to nanoentities can be measured and, thus, a new door is opened for particle identification. Detecting vibration modes of bacteria, virus or protein can offer new possibilities for medicine development and treatment research.

In a preferred embodiment of the invention, the method comprises the use of two or more mechanical resonator sensors. (Note that a single mechanical resonator can act as a sensor, and also a set of mechanical resonators can act as one whole sensor or as many single sensors, depending on the coupling). More preferably, the two or more mechanical resonator sensors are non-identical in dimensions, materials or structure, having at least one different mechanical vibration mode. In this way, it is possible to provide the system with more vibration modes for the mechanical resonator sensors, and this makes the coupling between the analyte and the mechanical resonator sensor more likely to happen.

Even more advantageously, the two or more mechanical resonator sensors are coupled and possess collective modes covering a bandwidth of frequency. In this manner, even if only one mechanical resonator sensor presents strong coupling with the mechanical mode of the analyte, the system can detect the coupling and the resonance frequency of the analyte can be easily inferred.

In a preferred embodiment of the invention, there is only one mechanical resonator sensor. This can be achieved by tuning the mode/modes of the mechanical resonator until there is strong coupling between the analyte and the mechanical resonator sensor, without needing more mechanical resonator sensors, for instance by designing the mechanical resonator sensor or by changing its intrinsic resonant frequencies.

In a preferred embodiment of the invention, the at least one vibration mode of the at least one mechanical resonator sensor is tunable by changing its mass or stiffness. More advantageously, the change in the stiffness is induced by adding stress mechanically, optically, electrically, or with any conventional method.

In a preferred embodiment of the invention, at least one of the mechanical resonator sensors is immersed in a liquid droplet. It is achieved thereby, to establish the natural environment suitable for biological bacterium, virus and protein detection.

In a preferred embodiment of the invention, the method further comprises the step of estimating the mass, the stiffness, the internal dissipation, the Poisson coefficient and the shape of the analyte from the resonance frequency obtained in step e). This approach is different from the ones based only on effective mass estimation methods, because it provides the frequency data, which none of the methods in the past allows to measure.

In a preferred embodiment of the invention, the at least one mechanical resonator sensor is an optomechanical resonator in the shape of a microdisk made of a semiconductor and lies on a pedestal, geometrically configured to present its mechanical vibration modes lying between 100 MHz and 15 GHz, to lie in the frequency range relative to the mechanical vibration modes of the at least one analyte. Also, the vibration modes of the at least one analyte and the vibration modes of the at least one mechanical resonator sensor are mechanically, magnetically or capacitively couplable so they present strong coupling in at least one frequency.

More advantageously, the thickness of the at least one microdisk lies between 200 and 400 nm, the radius of the microdisk lies between 0.5 and 100 microns, the height of the pedestal lies between 1 and 3 microns and its radius between 50 and 20000 nm.

More advantageously, the at least one microdisk is made of a semiconductor (such as Gallium Arsenide or Silicon Dioxide) and/or the pedestal is made of Aluminum Gallium Arsenide.

In a preferred embodiment of the invention, at least one mechanical resonator sensor is a mechanical resonator in the shape of a resonator cantilever, a resonator bridge, a resonator membrane, a resonator drum, a resonator capillary, a suspended microchannel resonator, a resonator plate, a resonator disk, a resonator toroid, or any mechanically resonant structure, geometrically configured to present mechanical vibration modes (2′) in the range of 1 MHz and 300 GHz.

Also, the vibration modes of the at least one analyte and the vibration modes of the at least one mechanical resonator sensor can be mechanically, magnetically, electrically, optically, capacitively or by other means coupled in a way that they present strong coupling in at least one frequency.

The control and design on the dimensions of the different geometry aforementioned mechanical resonators, together with the material of the mechanical resonator sensor may provide with high measurable frequency mechanical resonances, capable of mechanically couple with the mechanical modes of the analyte.

In a preferred embodiment of the invention, the at least one analyte is a bacterium, a virus, a protein or a nanoparticle.

In a preferred embodiment of the invention, the method further comprises the use of a suspended waveguide placed at a distance between 100 to 1000 nm to the at least one mechanical resonator sensor to evanescently couple light on it.

In a preferred embodiment of the invention, the method further comprises the use of a tapered fibre placed at a distance between 10 to 500 nm to the at least one mechanical resonator sensor to evanescently couple light on it.

It is achieved thereby to provide with high resonance frequencies to the mechanical resonator sensors, because resonators presenting modes with low dissipation in fluids, such as radial breathing modes (RBM) are hard to develop and fabricate. In this manner, high resonance frequencies that can be coupled to those of the bacterium modes are thereby achieved.

In a preferred embodiment of the invention, where there are two or more mechanical resonator sensors, the two or more mechanical resonator sensors are arranged in an array.

In a preferred embodiment of the invention, the relative humidity and temperature surrounding the at least one analyte and the at least one mechanical resonator sensor is changed, and the method further comprises the reiteration of steps b), c), d) and e).

In a preferred embodiment of the invention, the method comprises using a first and a second mechanical resonator sensors (or several further secondary mechanical resonators sensors), wherein:
both first and second mechanical resonator sensors already are configured to conform a coupled system;
the first mechanical resonator sensor has at least one mechanical vibration mode in a frequency that is measurable (by any conventional well-known technique such as optical or electrical ones);
the second mechanical resonator sensor
   is smaller than the first mechanical resonator sensor and, thus, more sensitive;
   has at least one mechanical vibration mode of said second sensor non-measurable with any conventional well-known technique); and
   said at least one non-measurable mechanical vibration mode is close enough in frequency to at least one mode of the first mechanical resonator sensor so that the system first and second mechanical resonator sensors are couplable (meaning “able to be coupled”);
   the analyte is placed on the second mechanical resonator.

It is thereby achieved a higher sensitivity by placing the analyte on the second mechanical resonator sensor, since the system of resonators responds with the sensitivity of the resonator where the analyte has been deposited. Therefore, when deposited on the smaller resonator, the frequency variation of the collective resonances is proportional to the effective mass of the smaller resonator. As a consequence, the sensitivity of the non-identical coupled sensors is increased with respect to the sensitivity of the isolated larger resonator. Of course, the sensitivity of the second resonator sensor when isolated cannot be improved, so in case of not being coupled to the first resonator sensor, it would be not possible to access to its mechanical modes. Many other different kind of non-identical coupled resonators can be designed based on this principle, in order to further improve the sensitivity of standard mechanical resonators.

A further object of the invention refers to a system for the analysis of analytes through mechanical resonance transduction according to any of the claims, suitable for its use in the identification of cells, bacteria, virus, protein or micro and nanoparticles in the range of frequency between 1 MHz and 300 GHz, said system comprising:
a) at least one mechanical resonator sensor comprising means for receiving at least one analyte disposed thereon, wherein said analyte possesses at least one mechanical vibration mode and said mechanical resonator sensor possesses at least one mechanical vibration mode selectable in one or more working frequencies;
b) means for monitoring the mechanical spectra of the coupled system conformed by said analyte and said mechanical resonator sensor;
c) means for selecting the working frequency of one mechanical vibration mode of the mechanical resonator sensor;
wherein the system is adapted for carrying out a method according to any of embodiments described in the present document.

Thus, this invention allows obtaining a solution to the technical problem described in previous sections of the present document, offering a method and system for particle identification that univocally detects a nanoentity such as a bacterium, virus or protein. The method allows measurements in the natural environment in biology: liquids. The method is based on the vibration resonances of nanoentities and, more particularly, on the strong coupling detection and measurement between resonances of nanoentities and mechanical resonators. This method and system opens a doorway for characterization techniques at very high frequencies.

### DESCRIPTION OF THE DRAWINGS

The characteristics and advantages of this invention will be more apparent from the following detailed description, when read in conjunction with the accompanying drawings, in which:

FIG. 1A shows, according to a preferred embodiment of the invention, a top-view scanning electro microscopy (SEM) image of a microdisk resonator. FIG. 1B shows a numerical simulation of the first radial breathing mode at 547 MHz of such resonator.

FIG. 2A shows a scanning electron microscopy image of a Staphylococcus bacterium (800 nm in diameter). FIG. 2B shows a numerical simulation showing the deformation of the Staphylococcus bacterium when vibrating on its first flexural mode, with a vibration mode around 552 MHz.

FIG. 3A (top) shows a side view scanning electron microscopy image of a semiconductor disk, according to a preferred embodiment of the invention. FIG. 3A (bottom) shows a side view scanning electron microscopy image of a semiconductor disk with a Staphylococcus bacterium on top of it, according to a preferred embodiment of the invention. FIG. 3B shows the mechanical spectra of a semiconductor microdisk before and after the adsorption of a Staphylococcus bacterium, according to a preferred embodiment of the invention.

FIG. 4A shows the normalized frequency (resonance frequency divided by the resonance frequency of the isolated mechanical resonator sensor or detector) of the coupled system and the isolated bacterium as a function of the resonance frequency of the isolated mechanical resonator sensor. FIG. 4B shows simulated mode shape of four different mechanical modes of the bacterium showing their fundamental frequencies.

FIG. 5A shows the simulated mode shape of the second flexural mode of a cantilever (mechanical resonator sensor or detector). FIG. 5B shows the normalized frequency (resonance frequency divided by the resonance frequency of the isolated mechanical resonator sensor or detector) of the coupled system and the isolated bacterium as a function of the resonance frequency of the isolated mechanical resonator sensor.

FIG. 6A shows the simulated mode shape of the first flexural mode of a bridge. FIG. 6B shows the normalized frequency (resonance frequency divided by the resonance frequency of the isolated mechanical resonator sensor or detector) of the coupled system and the isolated bacterium as a function of the resonance frequency of the isolated mechanical resonator sensor.

### NUMERICAL REFERENCES USED IN THE DRAWINGS

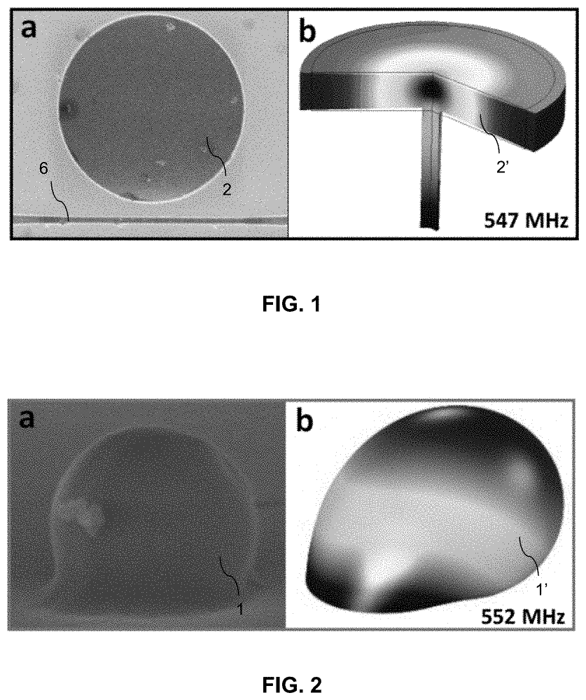

In order to provide a better understanding of the technical features of the invention, the referred FIGS. 1-6 are accompanied of a series of numeral references which, with illustrative and non limiting character, are hereby represented:

| | |
|---|---|
| (1) | Analyte |
| (1′) | Mechanical vibration mode/s of the analyte |
| (2) | Mechanical resonator sensor |
| (2′) | Mechanical vibration mode/s of the mechanical resonator sensor |
| (3) | External detector |
| (4) | Microdisk |
| (5) | Pedestal |
| (6) | Waveguide |

### DETAILED DESCRIPTION OF THE INVENTION

In the following description, for purposes of explanation and not limitation, details are set forth in order to provide a thorough understanding of the present invention. However, it will be apparent to those skilled in the art that the present invention may be practiced in other embodiments that depart from these details and descriptions without departing from the spirit and scope of the invention. Certain embodiments will be described below with reference to the drawings (FIG. 1-6) wherein illustrative features are denoted by reference numerals.

As described in previous sections, a main object of the invention is related to a method of mechanical resonance transduction for analyte detection and identification. The method is suitable for analytes with mechanical modes at high frequency range, typically between 1 MHz and 300 GHz. The invention is based on the effect of mechanical coupling between the analyte and the resonator wherein the analyte acts as a resonator itself.

According to the knowledge of the inventors of the present application, mechanical resonances of nanoentities such as bacteria, viruses or proteins have never been measured before. There are theoretical calculations for the range of frequencies where they must be located, with approximations that suggest that such vibration modes of bacteria, virus and protein, must be tiny oscillations that lie at MHz, GHz or at more than tens of GHz, respectively, due to their nanometric size.

In this context, the method of the present invention opens the door for a novel characterization technique that bases the detection and analyte (1) identification (in this document, the terms analyte, nanoentity, bacteria and particle will be treated as equivalent) on a coupling of the mechanical resonance of a (micro- or nano-) mechanical resonator sensor (2) and the mechanical resonance of the adsorbed analyte (1) (in this context, the mechanical resonator (2) is acting as a “sensor”). This coupling could be provided by any of the conventional coupling techniques such as, mechanical, optical, magnetic, capacitive, etc.

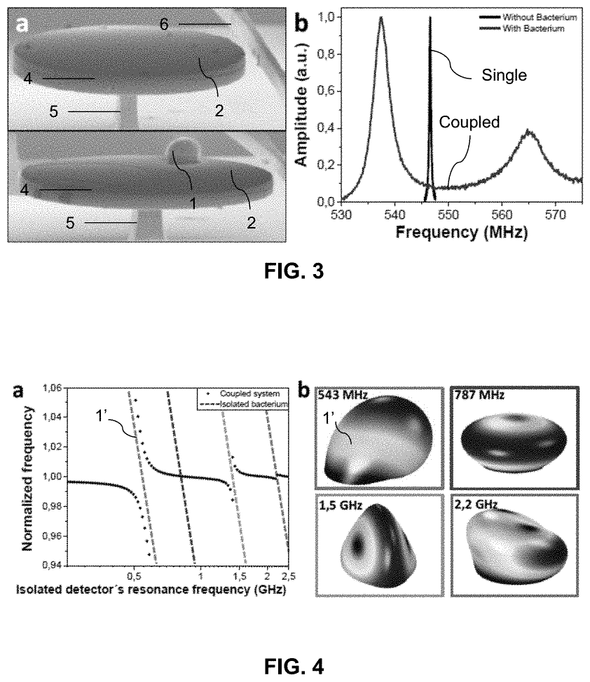

Generally, when two resonators are coupled through their frequency response and present collective modes, it is possible to extract information about the mechanical modes associated with the isolated structures by applying theoretical models. When applied to analytes (1), the conditions under which they can be detected though their mechanical resonances are typically the following:
On one hand, it is necessary to know an approximate range where the analyte (1) possesses at least one mechanical vibration mode (1′) (see FIG. 2).
On the other hand, at least one mechanical resonator sensor (2) is needed, and it must possess at least one mechanical vibration mode (2′), tunable (or selectable) in a plurality of working frequencies (See FIG. 1).
At least one mechanical vibration mode (2′) of the mechanical resonator sensor (2) must lie in a similar frequency range from at least one mechanical vibration mode (1′) of the analyte (1) in order for them to couple (See FIG. 3).
The mechanical coupling between both modes (1′, 2′) must be a strong coupling.

In the conditions described above, the term “working frequencies” means that al least one vibration mode (2′) can be tuned by other means (such as changing its stiffness, for instance, by adding stress) and shift it to other frequencies, conforming the plurality of working frequencies.

Also, the term “working frequencies” can also be referred to the situation where each one of the mechanical resonator sensors (2) (that is, one single mechanical resonator (2) or a set of mechanical resonators (2) acting as a sensor) has vibration modes at different frequencies, for example because they have different dimensions or are made by different materials. In that case, even without changing the intrinsic resonance frequency/ies of each mechanical resonator sensor (2), the one or the set of mechanical resonator sensors (2) covers a plurality of working frequencies and can be tuned or selected in one or more frequencies of such plurality by choosing or selecting one vibration mode.

Complementary to the term “working frequencies”, the term “tunable” and the term “selectable” for one or more mechanical resonator sensors (2) can be referred in the present context as synonyms and to the following situations:
an active tuning by changing the intrinsic resonance frequency/ies of a mechanical resonator sensor (2);
choosing or selecting a vibration mode from a set of vibration modes at different frequencies of a mechanical resonator sensor (2);
designing a mechanical resonator sensor (2) (material, dimensions, shape . . . ) so it has a particular vibration mode (or modes) at a certain desired frequency (or frequencies).

The term “strong coupling” will be illustrated as follows: when two resonators are not coupled, it means that the two single resonance frequencies are too separate. In this particular case of uncoupling, that would mean that the mechanical mode (1′) of the analyte (1) would not be detectable by itself while the mode (2′) of the mechanical resonator (2) would be indeed detectable and would appear as a single resonance peak (see FIG. 3b), maybe slightly modified by the added mass and/or stiffness, as Eq. 2 and Eq. 3 dictate. In this situation, the mechanical resonator (2) acts as a typical mass/stiffness sensor.

However, when the two resonators (1, 2) are mechanically coupled, it means that instead of detecting one single resonance corresponding to the single mechanical resonator (2), there is a splitting in two peaks for the resonance frequency; that is, when the two resonators are strongly coupled, two peaks are clearly seen. In this situation both resonators are vibrating at the same resonance frequency, having two collective modes: symmetric and antisymmetric (see FIG. 3b).

By definition, the mechanical coupling is related with the difference between the mechanical frequency of the symmetric and the antisymmetric modes at the maximum coupling (when both resonance frequencies of the analyte (1) and the mechanical resonator (2) are identical):

κ=(ω_{A}²−ω_{S}²)ₘᵢₙ/2ω₀² (Eq.4)

where ω₀² is the squared original frequency of the mechanical resonator (2), as well as of the analyte (1); κ is the coupling strength or coupling constant; ω_{S}² is the resonant frequency of the symmetric mode and ω_{A}² is the resonant frequency of the antisymmetric mode.

In order to fulfil the strong coupling situation, the coupling constant A has a lower threshold of κ>1/(3Q), where Q is the mechanical quality factor Q=ω₀/FWHM.

Therefore, in an embodiment of only one tunable mechanical resonator sensor (2) and one analyte (1) adsorbed on it, it is possible to estimate the resonance frequency of the analyte (1) through the frequency data of the coupling situation. That is, when the mechanical modes (1′, 2′) are perfectly matched in frequency, the distance between the two collective modes is minimized (Eq. 4). In this situation, dissipation of both collective modes is equal. Thus, by looking at the frequencies where this occurs, it is possible to infer the analyte's mechanical resonance frequencies (1′) and dissipation. Note that there is no need of comparing the isolated resonance frequency (2′) of the mechanical resonator sensor (2) with the coupling situation of the system, but just a single measurement is needed. This fact implies that the accuracy of the method is higher if compared with other analyte detection methods based on mass detection, because in the present case the measurement does not depend on the background (for example, if there is a lot of noise), while other methods must measure changes in the response of the mechanical resonator sensor (2).

This technique allows detecting the vibrations of micro and nanoscopic entities, such as bacteria, whose mechanical resonances have never been measured before, with extraordinary sensitivity, even accessing to their vibrations associated with the thermomechanical motion. Moreover, this technique can be exploited in order to develop ultrasensitive mass sensors based on mechanical structures composed by ‘non-identical coupled resonators’.

On the other hand, the detection of the mechanical vibrations can be obtained through through an external detector (3); that is, the use of any of the conventional optical and/or electrical methods of detection (beam deflection, interferometry, optomechanics, capacitively, electrostatically, etc.) Any of these methods use in the final step an oscilloscope, frequency locking, spectrum analyzer, high speed acquisition card, etc., for monitoring the mechanical resonance frequencies.

Once the fundamentals have been presented, let us show some preferred embodiments of the invention.

In a preferred embodiment of the invention, only one mechanical resonator sensor (2) (or detector) is employed and at least one analyte (1) is adsorbed. In such situation, the method of mechanical resonance transduction for analyte (1) vibration detection comprises preferably the following steps:
a) disposing the at least one analyte (1) that is to be detected, possessing at least one mechanical vibration mode (1′), on the mechanical resonator sensor (2) that possesses at least one mechanical vibration mode (2′), tunable or selectable in a plurality of working frequencies;
b) monitoring the mechanical spectra of the coupled system conformed by the analyte (1) and the mechanical resonator sensor (2);
c) varying one mechanical vibration mode (2′) of the mechanical resonator sensor in a plurality of working frequencies to approach said mechanical vibration mode (2′) to the mechanical vibration mode (1′) of the analyte until said mechanical vibration mode (2′) reaches a strong coupling situation with the mechanical vibration mode (1′);
d) determining the mechanical frequency at which the strong coupling occurs from the mechanical spectra measured in step b), as well as the dissipation of the collective modes of the coupled system conformed by the analyte (1) and the mechanical resonator sensor (2);
e) estimating the resonance frequency and dissipation of the mechanical vibration mode (1′) of the analyte from the strong coupling frequency data obtained in the previous step d).

It is understand in this context that the term “coupled” system and “strong coupled” system are slightly different, according to the general physical nomenclature. As a consequence, “monitoring a coupled system” means in this context that the two or more resonators (1, 2) are not separately monitored, but as a whole system. However, the term strong coupling means a high level of coupling, as it has been previously explained.

In a preferred embodiment of the invention, the mechanical resonator sensor (2) is an optomechanical platform based on a semiconductor microdisk (4) and the analyte (1) is a Staphylococcus bacterium. The sensitivity achieved comes from the using of semiconductor microdisks (4) as the mechanical resonator sensor (2) when injecting light on it. Such geometry, together with the material of the mechanical resonator sensor (2) provides with the high resonance frequency, capable of coupling with the analyte (1).

This is because semiconductor microdisks (4) support a family of mechanical modes in which they expand and contract radially (Radial breathing modes, RBM), which possess extremely high mechanical resonance frequencies, reaching the GHz range (FIG. 1). Importantly, these vibrations can be easily detected thanks to the extraordinary sensitivity to motion detection provided by the optomechanical effects present on this structures. In brief, semiconductor microdisks (4) also support high quality optical modes where photons are trapped circulating around their periphery (Whispering gallery modes, WGM). The optical wavelength associated to a given optical mode strongly depends on the resonator's dimensions. As a consequence, when the microdisks (4) expand and contract radially, the optical wavelength change. By injecting light on a microdisk (4), using an external laser at a fixed wavelength close to an optical mode, mechanical vibrations modulate the transmitted light, allowing their precise detection. In addition, mechanical modes where the mechanical resonator sensor (2) oscillates in plane, such as RBM, use to show lower mechanical energy dissipation when immersed in fluids, than conventional out of plane modes, such as the flexural modes of a cantilever.

Optomechanical devices make an ideal platform for applying this novel technique, due to their high frequency mechanical modes, high displacement sensitivity and low mechanical dissipation.

In FIG. 1A a top-view scanning electron microscopy image of a Gallium Arsenide microdisk with a radius of 2.5 microns and a thickness of 320 nm is shown. The microdisk (4) sits on an Aluminium Gallium Arsenide pedestal (5) with a height of 1.8 microns and a radius of 150 nm. An integrated and suspended waveguide (6) is placed close to the microdisk (4) to evanescently couple light on it. In FIG. 1B, a numerical simulation shows the deformation of the microdisk (4) when vibrating on its first radial breathing mode. Anisotropy of the material is taken into account. The simulated mechanical resonance frequency, 547 MHz, is in excellent agreement with the experimental results.

By placing a Staphylococcus bacterium (1) on a microdisk (4), mechanical modes of both entities can be coupled. The fact of being coupled or not, only depends on the separation of their mechanical resonances and the coupling strength that exists between them. In this case, coupling arise simply by mechanically contacting both resonators, however, other ways of coupling, such as optical, electrostatic or magnetic, could be applied. Importantly, mechanical coupling strength depends on the relative position of the bacterium (1) on the microdisk (4), as well as on the specific shape of their associated mechanical modes (1′). Fortunately, radial breathing modes (2′) of microdisks (4) couple very efficiently with certain modes (1′) of a bacterium (1). In addition, by designing the microdisks (4) properly, their mechanical resonances can be precisely matched to those (1′) of the Stapphylococus bacterium (1). If so, when depositing the bacterium (1) on the right position of the microdisk (4), mechanical modes (1′, 2′) of both entities get coupled (FIG. 3). When this happen, instead of measuring a single resonance (2′) associated with the radial breathing mode of the microdisk, two different mechanical resonances associated to the coupled system (FIG. 3B) are observed (strong coupling). Note that both modes show significantly higher mechanical dissipation than when measuring the isolated microdisks (4).

By applying an analytical model together with the experimental data, we can determine not only the resonance frequency of the bacterium (1), f_{bac}=(552±2) MHz, but also its mass, m_{bac}=(265±20) fg, and its Young's modulus E_{bac}=(5.5±0.5) MPa. Notably, the method allows measuring the intrinsic dissipation of the bacterium (1), a property that has been never measured before. Mechanical dissipation inside a material is usually translated into a complex value of the Young's Modulus, finally obtaining: Imag(E_{bac})=(0.22±0.02) MPa.

Implications and applications of this novel technique are multiple and highly innovative. Resonators emerge as transducers of the mechanical resonances of micro and nanoscopic entities, such as bacteria, viruses and nanoparticles, with unprecedented sensitivity. This finding opens the way for the development of a completely novel characterization technique of such entities, based on the measurement of their mechanical resonances, as well as, on the identification of the entities through them, the mechanical spectrometry and spectroscopy.

The mechanical resonances that supports a structure, depends on its particular shape, as well as on its mechanical properties, such as, its Young's modulus, its density and its Poisson's coefficient. Consequently, the measurement of these mechanical frequencies, provide a unique mechanical fingerprint of the detected entity, allowing its univocal identification. Importantly, the present method for detecting these resonances requires that both, the mechanical resonance of the mechanical resonator sensor (2) and the one of the analyte (1) are similar (for instance, by tuning the mechanical resonator vibration modes (2′) until one matches the analyte's mode (1′)).

This novel technique is not restricted to the use of optomechanical devices. Any other mechanical resonator sensor (2) can be used as a sensor or detector as well, with the condition of supporting measurable mechanical modes (2′) at very high frequency. As an example, lateral or extensional modes of conventional cantilever could reach also this frequency range if properly designed.

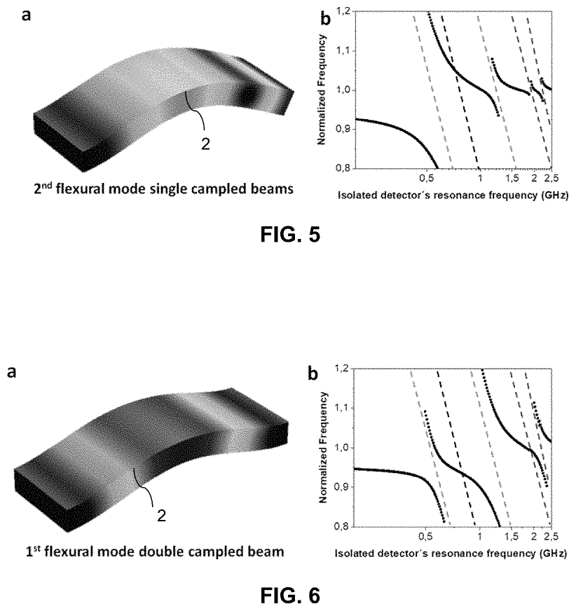

Indeed, the at least one mechanical resonator (2) can be in the shape of a cantilever, a bridge, a membrane, a drum, a capillary, a suspended microchannel, a plate, a disk, a toroid, or any other mechanically resonant structure, which possesses measurable mechanical modes by any existing conventional method, geometrically configured to present these mechanical modes in the range of MHz and/or GHz, to lie in the same frequency range than at least one mechanical vibration mode (1′) of the analyte (1). Also, the vibration modes (1′) of the at least one analyte (1) and the vibration modes of the at least one mechanical resonator (2) can be mechanically, magnetically, electrically, optically, capacitively or by other means coupled in a way that they present strong coupling in at least one frequency. (See FIGS. 5 and 6)

This requirement is needed because microscopic and nanoscopic entities, such as bacteria, virus and nanoparticles, possesses mechanical modes on this frequency range. As an example, the mechanical modes of a Staphylococcus bacterium (1) lies in the hundreds of MHz range (FIG. 2) and he one of a HIV virus in the GHz range. The technique can be further extended for the detection of even smaller entities, such as proteins, however it would be needed to access even higher frequencies mechanical modes.

In yet another preferred embodiment of the invention, the method comprises the using of two or more mechanical resonator sensors (2). The objective is to implement large bandwidth mechanical resonator sensors (2) in order to apply them for mechanical spectrometry and spectroscopy. In this preferred embodiment, the employed device consists on arrays of mechanical resonator sensors (2) with tiny different dimensions. This implementation presents an important disadvantage to the previous ones. Here, even if the whole system can access to a large bandwidth of frequencies, each mechanical resonator sensor (2) is a transducer of only a given mechanical frequency, therefore the bandwidth available for each individual event is limited.

In order to detect an analyte (1) in such discretised situation, in a preferred embodiment of the invention, several analytes (1) are disposed on several microdisks (4) (for instance, one analyte (1) on each microdisk (4)). Microdisks (4) are slightly different in dimensions, so their modes (2′) are also different. The method would comprise the step of measuring the resonance frequencies of all the microdisks (4) with the analyte (1) and the one that shows a splitting in the resonance frequency would match the resonance frequency of the analyte (1). Therefore, it would be possible to estimate in this manner the vibration mode (1′) of the analyte (1).

In yet another preferred embodiment of the invention, in order to circumvent the aforementioned problem, it is possible to use arrays of coupled resonators (2), identical or not. Coupled mechanical resonator sensors (2) possess collective modes (2′) covering a wide range of frequencies, in which every individual resonator is vibrating. As a consequence, no matter where the analyte (1) is deposited, every event has access to the entire bandwidth of the system.

1. System for the analysis of analytes through mechanical resonance transduction, suitable for its use in the identification of cells, bacteria, virus, protein or micro and nanoparticles in the range of frequency between 1 MHz and 300 GHz, said system being wherein it comprises:
a) at least one mechanical resonator sensor comprising means for receiving at least one analyte disposed thereon, wherein said analyte possesses at least one mechanical vibration mode and said mechanical resonator sensor possesses at least one mechanical vibration mode selectable in one or more working frequencies;
b) means for monitoring the mechanical spectra of the coupled system conformed by the analyte and the mechanical resonator sensor;
c) means for selecting a working frequency of one mechanical vibration mode of the mechanical resonator sensor such that the coupling constant κ between the mechanical vibration mode of the mechanical resonator sensor and the mechanical vibration mode of the analyte is greater than 1/(3Q), where Q is the quality factor of the mechanical resonator sensor.

2. System according to claim 1, comprising two or more mechanical resonator sensors.

3. System according to claim 1, wherein the two or more mechanical resonator sensors are non-identical in dimensions, materials or structure, having at least one different mechanical vibration mode.

4. System according to claim 2, wherein the two or more mechanical resonator sensors are coupled and possess collective modes covering a bandwidth of frequencies.

5. System according to claim 2, wherein:
the at least one mechanical resonator sensor is an optomechanical resonator in the shape of a microdisk made of a semiconductor and lies on a pedestal, geometrically configured to present its mechanical vibration modes lying between 1 MHz and 300 GHz, to lie in the frequency range relative to the mechanical vibration modes of the at least one analyte;
the vibration modes of the at least one analyte and the vibration modes of the at least one mechanical resonator sensor are mechanically, magnetically, electrically, optically or capacitively couplable so they present strong coupling in at least one frequency.

6. System according to claim 5, wherein:
the thickness of the at least one microdisk lies between 200 and 400 nm, the radius of the microdisk lies between 0.5 and 100 microns, the height of the pedestal lies between 1 and 3 microns and its radius between 50 and 20000 nm;
the at least one microdisk is made of Gallium Arsenide and the pedestal is made of Aluminum Gallium Arsenide;
the system further comprises a suspended waveguide placed at a distance between 100 to 300 nm to the at least one mechanical resonator to evanescently couple light on it.

7. System according to claim 1, wherein at least one mechanical resonator sensor is selected from the following: a resonator cantilever, a resonator bridge, a resonator membrane, a resonator drum, a resonator capillary, a suspended microchannel resonator, a resonator plate, a resonator disk, a resonator toroid, or any mechanically resonant structure, geometrically configured to present mechanical vibration modes in the range of 1 MHz and 300 GHz.

8. System according to claim 1, wherein the at least one analyte is a bacteria, a virus, a protein or a nanoparticle.

9. Method for the analysis of analytes through mechanical resonance transduction, suitable for its use in the identification of cells, bacteria, virus, protein or micro and nanoparticles in the range of frequency between 1 MHz and 300 GHz, said method being wherein it comprises the use of a system according to claim 1 and the following steps:
a) disposing at least one analyte that is to be detected on at least one mechanical resonator sensor, wherein said analyte possesses at least one mechanical vibration mode and said mechanical resonator sensor possesses at least one mechanical vibration mode selectable in one or more working frequencies;
b) monitoring the mechanical spectra of the coupled system conformed by the analyte (1) and the mechanical resonator sensor;
c) selecting the working frequency of one mechanical vibration mode of the mechanical resonator sensor to approach the mechanical vibration mode (1′) of the analyte, until at least the mechanical vibration mode of the mechanical resonator sensor strongly couples with one mechanical vibration mode of the analyte, wherein the condition of strong coupling is fulfilled when the coupling constant κ between the mechanical vibration mode of the mechanical resonator sensor (2) and the mechanical vibration mode of the analyte is greater than 1/(3Q), where Q is the quality factor of the mechanical resonator sensor;
d) determining the mechanical frequency at which the strong coupling occurs from the mechanical spectra measured in step b);
e) estimating the resonance frequency and quality factor of the mechanical vibration mode of the analyte, from the strong coupling frequency determined in step d).

10. Method according to claim 9 wherein the at least one vibration mode of the at least one mechanical resonator sensor is tunable by changing its mass or stiffness.

11. Method according to claim 9, wherein at least one of the mechanical resonator sensors is immersed in liquid or air.

12. Method according to claim 9, wherein at least one analyte is disposed on only one of the at least one mechanical resonator sensor.

13. Method according to claim 9, wherein the at least one analyte is a bacteria, a virus, a protein or a nanoparticle.

14. Method according to claim 9, wherein the method further comprises the step of estimating the mass, the stiffness, the internal dissipation, the Poisson coefficient and the shape of the analyte from the resonance frequency of step d).
